(19) United States
(12) Patent Application Publication
(10) Pub. No.: US 2008/0309736 A1
(43) Pub. Date: Dec. 18, 2008

(54) PIEZOELECTRIC INKJET HEAD

(75) Inventors: Sang-kwon Wee, Yongin-si (KR); So-young Oh, Yongin-si (KR); Hwa-sun Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/923,863

(22) Filed: Oct. 25, 2007

(30) Foreign Application Priority Data
Jun. 18, 2007 (KR) 2007-59518

(51) Int. Cl. B41J 2/045

(52) U.S. Cl. 347/71

(57) ABSTRACT

A piezoelectric inkjet head includes a plurality of pressure chambers in which ink to be ejected is filled. A plurality of piezoelectric actuators is respectively disposed in correspondence to the pressure chambers. A plurality of nozzles is in fluid communication with the pressure chambers, and at least two nozzles are formed in each of the pressure chambers.

### CROSS-REFERENCE TO RELATED APPLICATIONS

This application claims the benefit of Korean Patent Application No. 10-2007-0059518, filed on Jun. 18, 2007 in the Korean Intellectual Property Office, the disclosure of which is incorporated herein in its entirety by reference.

### BACKGROUND OF THE INVENTION

1. Field of the Invention

The present general inventive concept relates to a piezoelectric inkjet head, and more particularly, to a piezoelectric inkjet head which reduces cross talk generated between pressure chambers and has high printing resolution.

2. Description of the Related Art

In general, an inkjet head is an apparatus to print images having predetermined colors by ejecting minute droplets of printing ink on a surface of a printing medium, such as paper or textile. The inkjet head can be classified according to the ink ejection method. One type of inkjet head is a thermal head that generates bubbles in ink using a heater, thereby ejecting ink droplets due to an expanding force of the bubbles. The other type is a piezoelectric head that ejects ink droplets using pressure applied to ink through deformation of a piezoelectric device.

The piezoelectric inkjet head is used not only in inkjet printers in office automation (OA), but also in industrial inkjet printers, and also has recently been used in the manufacture process of a color filter in LCDs, the manufacture of organic light emitting diodes (OLED), and in printing fields like metal jetting, which requires high printing precision.

FIG. 1 is a plane view illustrating a conventional piezoelectric inkjet head, and FIG. 2 is a cross-sectional view taken along II-II′ of FIG. 1.

Referring to FIGS. 1 and 2, the conventional piezoelectric inkjet head includes a passage plate 20, in which an ink passage is formed, a nozzle plate 30, in which a plurality of nozzles 32 are formed through which ink is ejected, and a plurality of piezoelectric actuators 40. The passage plate 20 and the nozzle plate 30 can be formed of silicon. A manifold 21, a plurality of restrictors 23, and a plurality of pressure chambers 22 are formed in the passage plate 20. The manifold 21 is a passage through which ink inflows from an ink reservoir (not illustrated), and the pressure chambers 22 are to be filled with ink, and may be aligned one a side, or on both sides of the manifold 21. The restrictors 23 are paths that connect the manifold 21 and the pressure chambers 22. Meanwhile, a plurality of dampers 24, which connect the nozzles 32 and the pressure chambers 22, may be further formed in the passage plate 20. Also, a plurality of piezoelectric actuators 40 are formed on the passage plate 20, which is disposed above the pressure chambers 22. The piezoelectric actuators 40 may include a bottom electrode (not illustrated) that is formed to cover an upper surface of the passage plate 20 and functions as a common electrode, a piezoelectric layer (not illustrated) that is formed on the upper surface of the bottom electrode and is deformed according to driving signals, and a top electrode (not illustrated) that is formed on the upper surface of the piezoelectric layer and functions as a driving electrode. The passage plate 20 disposed above the pressure chambers 22 functions as a diaphragm, which is deformed according to the driving state of the piezoelectric actuators 40.

In the conventional piezoelectric inkjet head, when a driving signal is applied to the piezoelectric actuators 40, the passage plate 20 disposed above the pressure chambers 22 is deformed and the volume of the pressure chambers 22 is reduced, and thus the pressure in the pressure chambers 22 is increased and accordingly, ink is ejected through the nozzles 32 to the outside. Then, when the driving signal which was applied to the piezoelectric actuator 40 is no longer generated, the volume of the pressure chambers 22 is increased and the pressure in the pressure chambers 22 is reduced, and thus ink is refilled into the pressure chambers 22 from the manifold 21 through the restrictors 23.

However, in the conventional piezoelectric inkjet head, when ink is ejected according to the driving of the piezoelectric actuator 40, the ink is not only ejected through the nozzles 32, but also reflows partially to the manifold 21 through the restrictors 23. The reflowing ink generates pressure waves, and these pressure waves are dissipated to other neighboring pressure chambers 22 through the manifold 21. Such a phenomenon is called cross talk. The cross talk makes the meniscus of ink at the nozzles 32, which are connected to the neighboring pressure chambers 22, unstable, and accordingly, the speed and volume of the ink droplets which are ejected through the nozzles 32 may become irregular. Also, as the ink reflows, the amount of ink ejected through the nozzles 32 may become smaller than the desired amount.

### SUMMARY OF THE INVENTION

The present general inventive concept provides a piezoelectric inkjet head that reduces cross talk generated between the pressure chambers and has high printing resolution.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a piezoelectric inkjet head comprising a plurality of pressure chambers in which ink to be ejected is filled, a plurality of piezoelectric actuators to deform the pressure chambers, and a plurality of nozzles in fluid communication with the pressure chambers, wherein at least two nozzles are formed corresponding to each of the pressure chambers.

The nozzles may be aligned parallel to the direction in which the pressure chambers are aligned. The nozzles may be aligned at a side of the pressure chambers. In this case, a lateral portion of the pressure chambers may diverge into at least two extensions, and the nozzles may be formed in the extensions.

The nozzles may be aligned in a direction perpendicular to the direction in which the pressure chambers are aligned. The nozzles may be aligned on both sides of the pressure chambers. In this case, the nozzles may be aligned symmetrically to the center of the pressure chambers.

The piezoelectric inkjet head may further comprise a manifold to supply ink to the pressure chambers and a plurality of restrictors connecting the pressure chambers and the manifold. Also, the piezoelectric inkjet head may further comprise a plurality of dampers connecting the pressure chambers and the nozzles.

The foregoing and/or other aspects and utilities of the present general inventive concept may also be achieved by providing a piezoelectric inkjet head comprising a plurality of first and second pressure chambers facing each other, a plurality of first and second piezoelectric actuators disposed to correspond with the first and second pressure chambers, and a plurality of first and second nozzles in fluid communication with the first and second pressure chambers, wherein at least two first and second nozzles are formed corresponding to the first and second pressure chambers.

The first and second nozzles may be aligned parallel to the direction in which the first and second pressure chambers are aligned. Lateral portions of the first and second pressure chambers facing each other may respectively diverge into at least two extensions, and the first and second nozzles may be connected to the extensions of the first pressure chambers and the extensions of the second pressure chambers, respectively. The first and second nozzles may be alternatingly aligned on the same line.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a plane view illustrating a conventional piezoelectric inkjet head;

FIG. 2 is a cross-sectional view taken along II-II′ of FIG. 1;

FIG. 3 is a plane view illustrating a piezoelectric inkjet head according to an embodiment of the present general inventive concept;

FIG. 4 is a cross-sectional view taken along IV-IV′ of FIG. 3;

FIG. 5 is a cross-sectional view taken along V-V′ of FIG. 3;

FIG. 6 is a plane view illustrating a piezoelectric inkjet head according to another embodiment of the present general inventive concept;

FIG. 7 is a plane view illustrating a piezoelectric inkjet head according to another embodiment of the present general inventive concept; and

FIG. 8 is a cross-sectional view taken along VIII-VIII′ of FIG. 7.

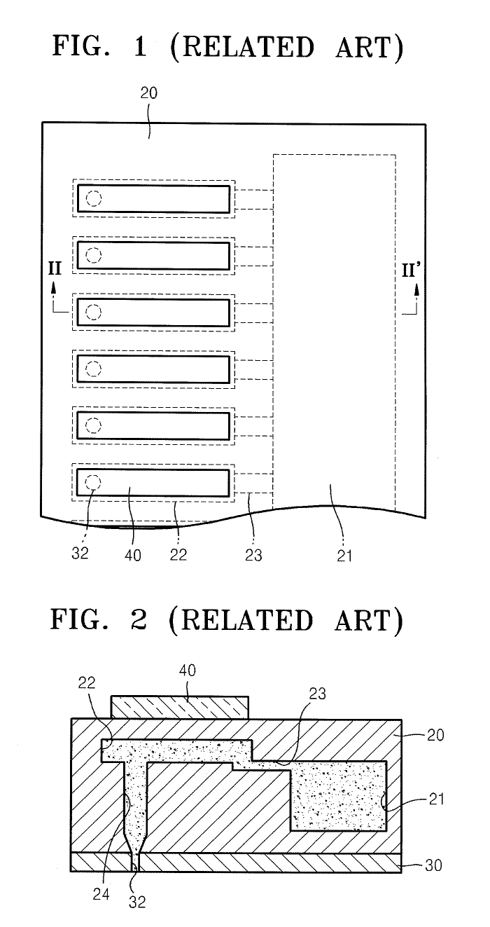

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

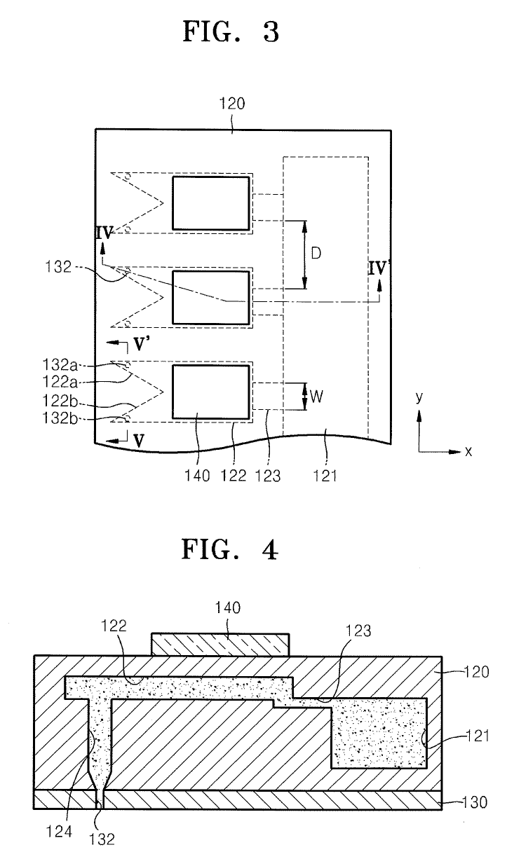

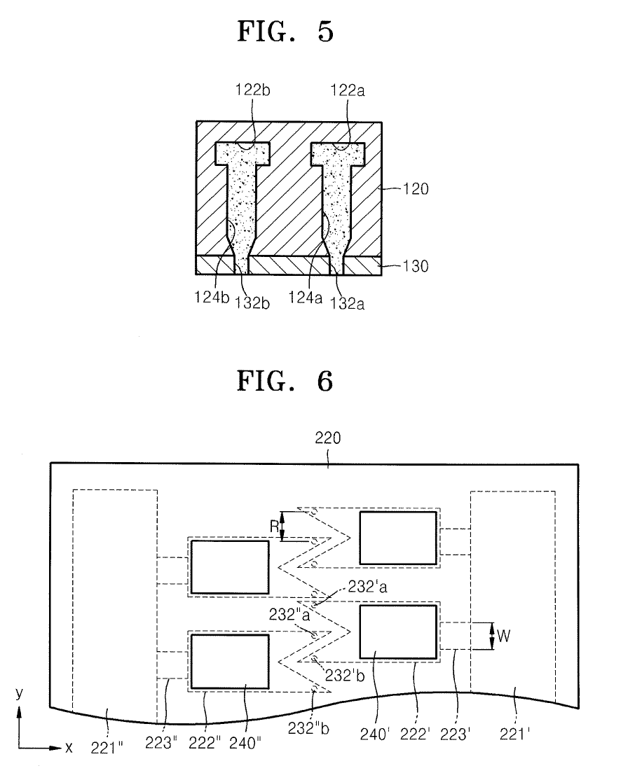

FIG. 3 is a plane view illustrating an inkjet head according to an embodiment of the present general inventive concept. FIG. 4 is a cross-sectional view taken along IV-IV′ of FIG. 3. FIG. 5 is a cross-sectional view taken along V-V′ of FIG. 3.

Referring to FIGS. 3 through 5, the piezoelectric inkjet head includes a passage plate 120, in which ink passages are formed, a nozzle plate 130, in which a plurality of nozzles 132 are formed, and a plurality of piezoelectric actuators 140. The passage plate 120 and the nozzle plate 130 may be formed of a material suitable to construct small scale structures, such as silicon.

In the exemplary passage plate 120, a manifold 121, which is a common passage, a plurality of pressure chambers 122 and restrictors 123, which are separate passages, are formed. The manifold 121 supplies ink to the pressure chambers 122, and may be formed parallel to the direction (y-direction) in which the pressure chambers 122 are aligned. Ink may be supplied to the manifold 21 from an ink reservoir (not illustrated). The pressure chambers 122 are filled with ink that is to be ejected, and may be aligned along one side, or on both sides, of the manifold 121. The restrictors 123 are paths that connect the manifold 121 and the pressure chambers 122.

A plurality of the piezoelectric actuators 140 are formed on the passage plate 120 respectively aligned to the pressure chambers 122. The piezoelectric actuators 140 change the pressure inside the pressure chambers 122 by vibrating or otherwise deforming the portion of the passage plate 120 that is disposed above the pressure chambers 122. The portion of the passage plate 120 disposed above the pressure chambers 122 functions as a diaphragm that is deformed as the piezoelectric actuators 140 are driven. The piezoelectric actuators 140 may include a bottom electrode (not illustrated), which is formed to cover the upper surface of the passage plate, a piezoelectric layer (not illustrated) formed on the bottom electrode, and a top electrode (not illustrated) that is formed on the piezoelectric layer. The bottom electrode may function as a common electrode, and the top electrode may function as a driving electrode that receives voltages to be applied thereby across the piezoelectric layer. The piezoelectric layer is deformed by the applied voltages, and thus deforms a portion of the passage plate 120 that is disposed above the pressure chambers 122. The piezoelectric layer may be formed of a predetermined piezoelectric material, for example, a lead zirconate titanate (PZT) ceramic material. It is to be understood that while the exemplary embodiments utilize piezoelectric actuators 140 to deform the pressure chambers 122, other actuators may be implemented to deform the pressure chambers 122 without departing from the spirit and intended scope of the present general inventive concept.

A nozzle plate 130, in which a plurality of nozzles is formed, as representatively illustrated at 132a and 132b and connected to the pressure chambers 122, is disposed on a lower surface of the passage plate 120. In certain embodiments of the present general inventive concept, at least two nozzles 132a and 132b are formed in fluid communication with each of the pressure chambers 122, and the nozzles 132a and 132b may be aligned in a direction parallel to the aligning direction (y-direction) of the pressure chambers 122. The nozzles 132a and 132b may be aligned along a side of the pressure chamber 122. In certain embodiments, a distal portion of the pressure chamber 122 diverges into at least two extensions 122a and 122b, and the nozzles 132a and 132b are in respective communication with the diverged extensions 122a and 122b. In addition, a plurality of dampers 124a and 124b, which connect the pressure chamber extensions 122a and 122b, and the nozzles 132a and 132b, may be further formed in the passage plate 120. In this case, the dampers 124a and 124b correspond to the nozzles 132a and 132b, and thus at least two dampers 124a and 124b are formed in respective fluid communication with each of the pressure chamber extensions 122a and 122b. Meanwhile, as illustrated in the current embodiment, the restrictors 123 may be formed to have a width W that allows ink in the manifold 121 to flow more easily into the corresponding pressure chambers 122.

In the current embodiment of the present general inventive concept, when at least two nozzles 132a and 132b are formed in fluid communication with one pressure chamber 122 in a parallel direction to the direction in which the pressure chambers 122 are aligned, the distance D between neighboring restrictors 123 can be increased to reduce the influence of cross talk generated during ink ejection. Accordingly, when performing high frequency printing, a decrease in the flow amount of ink or irregularity of ejected ink droplets, which are caused by the increased influence of cross talk, can be prevented. Also, in minute pattern printing, high resolution printing can be realized by reducing the distance between the nozzles 132a and 132b, which is illustrated further below.

In the embodiments of the present general inventive concept described thus far, the lateral portions of the pressure chambers 122 diverge into at least two extensions 122a and 122b and the nozzles 132a and 132b are connected to the diverged extensions. However, the present general inventive concept is not limited thereto. For example, the pressure chambers 122 may also be connected to the nozzles 132a and 132b through extensions of other geometries. In addition, although two nozzles 132a and 132b are formed corresponding to each of the pressure chambers 122 in the above described embodiment, the present general inventive concept is not limited thereto. For example, three or more nozzles may also be formed to communicate with one pressure chamber 122. Also, in the above-described embodiment, the inkjet head is formed of two plates, that is, the passage plate 120 and the nozzle plate 130. However, this is merely an example, and various modifications are possible. For example, the passage plate 120 and the nozzle plate 130 may be formed as a single unit. Also, the illustrated structure of the passage plate 120 may be defined by a plurality of plates that are stacked and bonded one to another. For example, the passage plate 120 may have a structure constructed by bonding a plate in which the pressure chambers 122 are formed and a plate in which the manifold 121 and the restrictors 123 are formed.

FIG. 6 is a plane view illustrating a piezoelectric inkjet head according to another embodiment of the present general inventive concept.

Referring to FIG. 6, a plurality of first and second pressure chambers 222′ and 222″, first and second manifolds 221′ and 221″, and first and second restrictors 223′ and 223″, are formed in the exemplary passage plate 220. The first and second pressure chambers 222′ and 222″ are aligned in facing staggered relationship with each other. The first and second manifolds 221′ and 221″ supply ink to the pressure chambers 222′ and 222″, respectively, and are formed parallel to the direction in which the first and second pressure chambers 222′ and 222″ are aligned (y-direction) on the outside of the first and second pressure chambers 222′ and 222″. A plurality of first restrictors 223′ are formed between the first pressure chambers 222′ and the first manifold 221′, and a plurality of second restrictors 223″ are formed between the second pressure chambers 222″ and the second manifold 221″. Also, a plurality of first and second piezoelectric actuators 240′ and 240″ are formed on the passage plate 220, aligned with the first and second pressure chambers 222′ and 222″. The first piezoelectric actuators 240′ are disposed above the first pressure chamber 222′ and the second piezoelectric actuator 240″ are disposed above the second pressure chamber 222″. The first and second piezoelectric actuators 240′ and 240″ may be similar to those described above, and thus, a description thereof will be omitted.

A nozzle plate, such as one similar to nozzle plate 130 above, is formed in which a plurality of first and second nozzles 232′a, 232′b, 232″a, and 232″b connected to the pressure chambers 222′ and 222″, and is disposed on a lower surface of the passage plate 220. At least two first and second nozzles 232′a, 232′b, 232″a, and 232″b are formed in fluid communication with the first and second pressure chambers 222′ and 222″. The first and second nozzles 232′a, 232′b, 232″a, and 232″b are aligned parallel to the direction in which the first and second pressure chambers 222′ and 222″ are aligned (y-direction). In detail, the first and second nozzles 232′a, 232′b, 232″a, and 232″b may be formed on inner sides of the first and second pressure chambers 222′ and 222″, that is, on sides of the first and second pressure chambers 222′ and 222″ facing each other. In this case, the first and second nozzles 232′a, 232′b, 232″a, and 232″b may be aligned along a common line so that nozzles coupled to each pressure chamber 222′ and 222″ alternate thereon. To this end, inner sides of the first and second pressure chambers 222′ and 222″, that is, the sides of the first and second pressure chambers 222′ and 222″ facing each other, respectively diverge into at least two extensions, and the extensions of the first pressure chambers 222′ and the extensions of the second pressure chambers 222″ are interstitially arranged. Also, the extensions of the first pressure chamber 222′ are connected to the first nozzles 232′a and 232′b, and the extensions of the second pressure chamber 222″ are connected to the second nozzles 232″a and 232″b. Meanwhile, a plurality of first dampers (not illustrated) that connect the first pressure chambers 222′ and the first nozzles 232′a, 232′b and a plurality of second dampers (not illustrated) that connect the second pressure chambers 222″ and the second nozzles 232″a, 232″b may further be formed in the passage plate 220. In this case, the first and second dampers correspond to the first and second nozzles 232′a, 232′b, 232″a, and 232″b, and thus at least two first dampers are formed with respect to each of the first pressure chambers 222′, and at least two second dampers are formed with respect to each of the second pressure chambers 222″. Meanwhile, in the current embodiment, the width W of the first and second restrictors 223′ and 223″ can be formed so that the ink in the first and second manifold 221′ and 221″ can easily flow into the first and second pressure chambers 222′ and 222″

In the current embodiment of the present general inventive concept, when the at least two first and second nozzles 232′a, 232′b, 232″a, and 232″b are alternately formed with respect to the first and second pressure chambers 222′ and 222″, respectively, the distance R between the nozzles 232′a, 232′b, 232″a, and 232″b can be established to print at high resolution. Thus, when manufacturing a color filter having smaller pixels than a color filter used in a conventional liquid crystal display (LCD) using a printing method, cross talk can be reduced by using the above described inkjet head according to the present general inventive concept, and high resolution printing can be realized.

Meanwhile, although two nozzles 232′a, 232′b, 232″a, and 232″b are formed with respect to each of the first and second pressure chambers 222′ and 222″, the present general inventive concept is not limited thereto, and three or more nozzles may also be formed with respect to one pressure chamber.

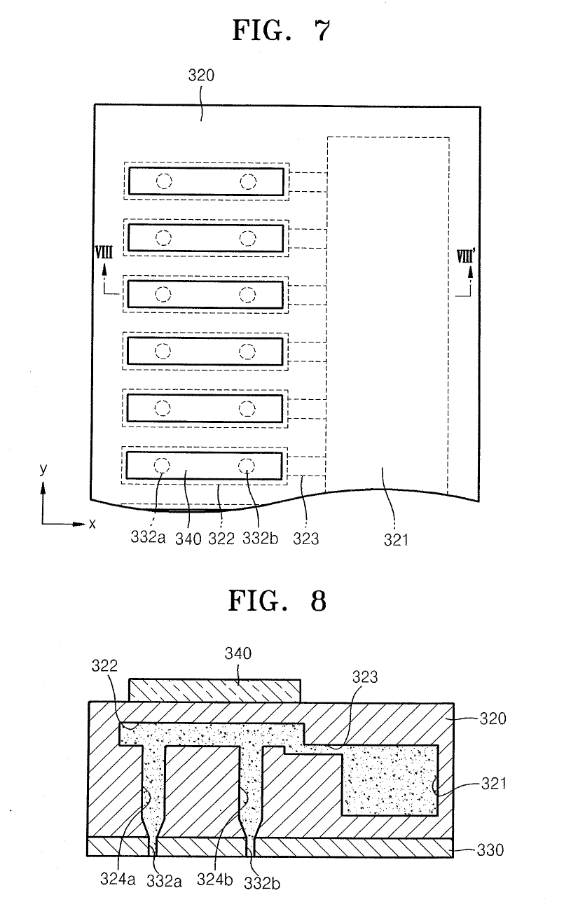

FIG. 7 is a plane view illustrating a piezoelectric inkjet head according to another embodiment of the present general inventive concept, and FIG. 8 is a cross-sectional view taken along VIII-VIII′ of FIG. 7.

Referring to FIGS. 7 and 8, in a passage plate 320, a plurality of pressure chambers 322 in which ink to be ejected is filled, a manifold 321 to supply ink to the pressure chambers 322, and a plurality of restrictors 323 connecting the pressure chambers 322 and the manifold 321, are formed. The manifold 321 may be formed parallel to the direction in which the pressure chambers 322 are aligned (y-direction) along a side of the pressure chambers 322. Also, a plurality of piezoelectric actuators 340 may be formed on the passage plate 320, respectively aligned with the pressure chambers 322. The piezoelectric actuators 340 may be disposed above the pressure chambers 322. The piezoelectric actuators 340 may be similar to those described above, and the description thereof will thus be omitted.

A nozzle plate 330, in which a plurality of nozzles 332a and 332b are formed, each of which is to be connected to a corresponding one of the pressure chambers 322, is formed on a lower surface of the passage plate 320. At least two nozzles 332a and 332b are formed in fluid communication with each of the pressure chambers 322. The nozzles 332a and 332b corresponding to each one of the pressure chambers 322 are aligned in a direction perpendicular to the direction in which the pressure chambers 322 are aligned (x-direction). The nozzles 332a and 332b may be aligned on both sides of the pressure chambers 322. In this case, the nozzles 332a and 332b may be aligned symmetrically to the center of the pressure chamber 322. However, the present general inventive concept is not limited thereto, and the nozzles 332a and 332b may be aligned in a variety of arrangements. Meanwhile, a plurality of dampers 324a and 324b that connect the pressure chambers 322 and the nozzles 332a and 332b may further be formed in the passage plate 320. In this case, since the dampers 324a and 324b correspond to the nozzles 332a and 332b, at least two dampers 324a and 324b are formed with respect to each of the pressure chambers 322.

When two or more nozzles 332a and 332b are formed with respect to one pressure chamber 322 in a perpendicular direction to the aligning direction of the pressure chambers 322, high speed printing can be realized. In detail, in the conventional art, when a color filter is manufactured, ink droplets are sequentially ejected from one nozzle corresponding to one pressure chamber and are filled in one pixel. However, when using the inkjet head according to the current embodiment of the present general inventive concept, ink droplets are ejected simultaneously from the two or more nozzles 322a and 322b that correspond to one pressure chamber 322, and thus a color filter can be manufactured at a higher speed than in the conventional art.

In the above-described embodiment, two nozzles 332a and 332b are formed in fluid communication with each of the pressure chambers 322. However, the present general inventive concept is not limited thereto, and three or more nozzles may also be formed in fluid communication with one pressure chamber 322.

When two or more nozzles are formed in fluid communication with one pressure chamber and aligned in parallel to the direction in which the pressure chambers are aligned, the distance between neighboring restrictors can be increased compared to the conventional art. Thus, influences caused by cross talk during ink ejection can be reduced. Accordingly, a decrease in the flow amount of ejected ink droplets or an irregularity of the volume of the ejected ink droplets, which are caused by the influence of cross talk, can be prevented. Also, when performing minute pattern printing, high resolution printing can be realized by reducing the distance between the nozzles.

Further, printing at higher resolution can be realized by forming two or more nozzle in each of facing pressure chambers and aligning the nozzles so that adjacent nozzles are in fluid communication with alternating pressure chambers.

Additionally, when two or more nozzles are formed in fluid communication with one pressure chamber in a direction perpendicular to the direction in which the pressure chambers are aligned, high speed printing can be realized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A piezoelectric inkjet head comprising:
a plurality of pressure chambers to fill with ink;
a plurality of piezoelectric actuators to deform the pressure chambers; and
a plurality of nozzles in fluid communication with each of the pressure chambers to eject ink.

2. The piezoelectric inkjet head of claim 1, wherein the nozzles are aligned parallel to a direction in which the pressure chambers are aligned.

3. The piezoelectric inkjet head of claim 2, wherein the nozzles are aligned along a side of the pressure chambers.

4. The piezoelectric inkjet head of claim 3, wherein a lateral portion of each of the pressure chambers diverges into at least two extensions, and the nozzles are formed in the extensions.

5. The piezoelectric inkjet head of claim 1, wherein the nozzles are aligned in a direction perpendicular to the direction in which the pressure chambers are aligned.

6. The piezoelectric inkjet head of claim 5, wherein the nozzles are aligned on opposing sides of the pressure chambers.

7. The piezoelectric inkjet head of claim 6, wherein the nozzles are aligned symmetrically to a center of the pressure chambers.

8. The piezoelectric inkjet head of claim 1, further comprising a manifold to supply ink to the pressure chambers.

9. The piezoelectric inkjet head of claim 8, wherein the manifold is formed parallel to a direction in which the pressure chambers are aligned.

10. The piezoelectric inkjet head of claim 8, further comprising a plurality of restrictors connecting the pressure chambers and the manifold.

11. The piezoelectric inkjet head of claim 10, further comprising a plurality of dampers connecting the pressure chambers and the nozzles.

12. The piezoelectric inkjet head of claim 11, further comprising:
a passage plate in which the manifold, the pressure chambers, the restrictors, and the dampers are formed; and
a nozzle plate which is formed on a lower surface of the passage plate and in which the nozzles are formed.

13. The piezoelectric inkjet head of claim 12, wherein the piezoelectric actuators are formed on the passage plate above the pressure chambers.

14. A piezoelectric inkjet head comprising:
a plurality of first and second pressure chambers facing each other;
a plurality of first and second piezoelectric actuators to respectively deform the first and second pressure chambers; and
a plurality of first and second nozzles in respective fluid communication with the first and second pressure chambers,
wherein at least two first and second nozzles are formed corresponding to the first and second pressure chambers, respectively.

15. The piezoelectric inkjet head of claim 14, wherein the first and second nozzles are aligned parallel to the direction in which the first and second pressure chambers are aligned.

16. The piezoelectric inkjet head of claim 15, wherein lateral portions of the first and second pressure chambers facing each other respectively diverge into at least two extensions, and the first and second nozzles are respectively formed in the extensions of the first pressure chambers and the extensions of the second pressure chambers.

17. The piezoelectric inkjet head of claim 16, wherein the first and second nozzles are alternatingly aligned on a common line.

18. The piezoelectric inkjet head of claim 14, further comprising first and second manifolds to supplying ink to the first and second pressure chambers.

19. The piezoelectric inkjet head of claim 18, wherein the first and second manifolds are formed parallel to the direction in which the first and second pressure chambers are aligned.

20. The piezoelectric inkjet head of claim 18, further comprising:
a plurality of first restrictors connecting the first pressure chambers and the first manifolds; and
a plurality of second restrictors connecting the second pressure chambers and the second manifolds.

21. The piezoelectric inkjet head of claim 20, further comprising:
a plurality of first dampers connecting the first pressure chambers and the first nozzles; and
a plurality of second dampers connecting the second pressure chambers and the second nozzles.

22. The piezoelectric inkjet head of claim 21, comprising:
a passage plate in which the first and second manifolds, the first and second pressure chambers, the first and second restrictors, and the first and second dampers are formed; and
a nozzle plate disposed on a lower surface of the passage plate and in which the first and second nozzles are formed.

23. The piezoelectric inkjet head of claim 22, wherein the first and second piezoelectric actuators are formed on the passage plate above the first and second pressure chambers.
